(19) United States
(12) Patent Application Publication
(10) Pub. No.: US 2020/0354073 A1
(43) Pub. Date: Nov. 12, 2020

(54) REDUNDANT AVIATION POWERTRAIN SYSTEM FOR RELIABILITY AND SAFETY

(71) Applicant: Valery Miftakhov, San Carlos, CA (US)

(72) Inventor: Valery Miftakhov, San Carlos, CA (US)

(21) Appl. No.: 16/798,273

(22) Filed: Feb. 21, 2020

Related U.S. Application Data
(60) Provisional application No. 62/808,312, filed on Feb. 21, 2019.

(51) Int. Cl. B64D 35/08; B64D 27/24; B64D 31/00; B64D 35/02

(52) U.S. Cl. CPC B64D 35/08; B64D 35/02; B64D 31/00; B64D 27/24

(57) ABSTRACT

An aircraft power plant comprising multiple electric drivetrains combined through a single output shaft, wherein each drivetrain is completely separate from the other, containing individual power sources, motor controllers, and motors, wherein the motors could be selected to provide efficient direct drive to the propulsor at the target propulsor RPM, to facilitate combining multiple motors on the same shaft without requiring mechanical gearboxes. During normal operation, each drivetrain will be operating below their maximum output levels, extending the durability of the motor controllers and motors.

### CROSS-REFERENCE TO RELATED PATENT APPLICATION

This regular U.S. patent application relies upon and claims the benefit of priority from U.S. provisional patent application No. 62/808,312, entitled “REDUNDANT AVIATION POWERTRAIN SYSTEM FOR RELIABILITY AND SAFETY,” filed on Feb. 21, 2019, which is incorporated by reference herein in its entirety.

### BACKGROUND OF THE INVENTION

### Field of the Invention

The disclosed embodiments relate in general to clean energy based air transportation systems technology, and, more specifically, to redundant aviation powertrain system for reliability and safety.

### Description of the Related Art

According to numbers from the FAA, the number of pilot licenses issued every year is increasing. The largest collection of licenses is in the private category. Contributing to this pattern, the lowest barrier of entry into private aviation is through the use of small single engine aircraft. These aircraft usually employ a single piston gasoline engine as the primary method of forward propulsion.

Coincidentally, these small single engined aircraft contribute the highest number of safety infractions and accidents in general aviation. A number of factors drive this statistics, with one of the large contributors being the fact that a vast majority of these general aviation aircraft have only one engine. In case of that single engine failure an aircraft encounters a seriously hazardous condition and has to land immediately. If that occurs over mountainous terrain, at night, or in the Instrumental Meteorological Conditions (IMC), the outcome is often tragic.

Another contributing factor to this issue is the fact that a traditional internal combustion aviation engine contains a large number of moving parts, operating under large mechanical and thermal stresses. This negatively affects reliability of components, and significantly limits useful life of the engines and increases probability of failure per hour of operation. As a result, the aircraft operators are forced to perform frequent and extensive maintenance of the engines on their fleet, driving the cost of operating traditionally-powered aircraft, and in turn drive the cost of air transportation to the end user.

### SUMMARY OF THE INVENTION

The inventive methodology is directed to methods and systems that substantially obviate one or more of the above and other problems associated with conventional technology.

In accordance with one aspect of the embodiments described herein, there is provided an aircraft power plant comprising multiple electric drivetrains combined through a single output shaft, wherein each drivetrain is completely separate from the other, containing individual power sources, motor controllers, and motors, wherein the motors could be selected to provide efficient direct drive to the propulsor at the target propulsor RPM, to facilitate combining multiple motors on the same shaft without requiring mechanical gearboxes.

In one or more embodiments, during normal operation, each drivetrain will be operating below their maximum output levels, extending the durability of the motor controllers and motors.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detai

led description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary overall architecture.

FIG. 2 illustrates example redundant battery system for a 250 kW Piper Matric powertrain.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

To combat the inherent disadvantage of the single-engine aircraft, larger commercial aircraft usually utilizes two or more engines. Unfortunately, this was traditionally not a viable option for smaller aircraft due to cost and complexity, and the vast majority of the aircraft with seat capacity below 10 passengers continue to use only one engine—even those that are operated commercially—e.g., Cessna Caravan, Pilatus PC12, etc. Additionally, multi-engine aircraft require significant additional pilot training due to a number of adverse effects linked to the asymmetry of thrust in case of a failure of one of the engines.

We propose a novel drivetrain (engine replacement) architecture that addresses the above concerns. Namely, a redundant multitude of electric drivetrain components, controlled by the master control software, is used to drive a single propulsor in our invention (the propulsor could be a traditional propeller of any complexity, a fan similar to the ones used in modern turbofan engines, or a rotor in a rotorcraft). This novel approach brings the following advantages:

In one or more embodiments, by reducing the component count through using electric motors, the overall safety and reliability is increased, and the maintenance cost is significantly reduced.

In one or more embodiments, while still utilizing a single propulsor (and therefore maintaining aerodynamic and handling simplicity of a single-engine setup), multiple redundant powertrain elements allow to achieve near-multi-engine reliability. The only common point of failure is the propulsor itself, which is generally regarded as one of the most reliable components of the aircraft propulsion system

We call this redundant arrangement a “Redundant Aviation Powertrain”, referred to as “powertrain” below.

Inventive Claims:

1. Multiple Electric Drivetrains Combined through a Single Output Shaft

In one or more embodiments, since the initial idea is not to increase the number of propulsors on the aircraft, but to increase the powertrain's reliability and safety, the idea is to combine two or more electric drivetrains outputting power through a single shaft to produce forward thrust through a single propulsor.

In one or more embodiments, each drivetrain will be completely separate from the other, containing individual power sources, motor controllers, and motors.

In one or more embodiments, the motors could be selected to provide efficient direct drive to the propulsor at the target propulsor RPM, to facilitate combining multiple motors on the same shaft without requiring mechanical gearboxes

In one or more embodiments, during normal operation, each drivetrain will be operating below their max output levels, extending the durability of the motor controllers and motors. This will extend the durability of components, require less user maintenance, and increase service life of all components.

In one or more embodiments, in case of a single-point failure in any of the powertrain components, the remaining components are designed to provide sufficient power to maintain at least the straight and level flight of the aircraft, and generally match the OEI (One Engine Inoperative) performance of a multi-engine aircraft.

2. Independent Control Systems for each Drivetrain

In one or more embodiments, each drivetrain consists of a power supply, a programmable logic controller, a motor controller and motor, a cooling system, and other associated devices. Each component will be an electronic item requiring control inputs and providing outputs for feedback and error monitoring.

In one or more embodiments, the center of each drivetrain will be a programmable logic controller (PLC) responsible for controlling each component. These PLCs will be independent of each other and make decisions individually.

In one or more embodiments, each control system will have identical sensor packages, in case of failure of one of the subsystems.

In one or more embodiments, each control system will be in constant communication with the other, and they will monitor each others' status. Each control system will have the ability to alert the pilot to errors on the other control system.

In one or more embodiments, each high power motor requires a motor controller in this drivetrain setup. These motor controllers register user inputs and control the motors to suit the user's request. These motor controllers, as with the rest of the system will be completely independent of each other.

3. Independent Power Supplies for Each Drivetrain

In one or more embodiments, each drivetrain will be powered by an individual source. This power source will be capable of supporting one drivetrain's peak power output in case of failure in the other drivetrains. These power sources, as with the rest of the system will be completely independent of each other. Multiple types of the power supplies can be used, including:

In one or more embodiments, electric battery, storing electrical energy electrochemically inside many individual cells, providing necessary system voltage and power

In one or more embodiments, fuel cell systems, producing electricity via catalytically-supported chemical reactions that non-combustively recombine fuel with oxygen from the air to produce electric current flow. One particularly interesting embodiment of the invention uses hydrogen fuel cells, for example a low-temperature PEM fuel cell with bipolar metal plates

In one or more embodiments, supercapacitor systems, storing energy in the electrical fields inside many individual cells

5. Independent Cooling Systems

In one or more embodiments, each drivetrain will require external cooling, via a controllable cooling system. This cooling system consists of a few temperature and pressure sensors, as well as a heat exchanger fan, and a coolant pump.

In one or more embodiments, individual cooling loops will keep both drivetrains sufficiently thermally isolated in case of damage or leaks in one system.

In one or more embodiments, the system will run more efficiently if one loop requires more cooling than the other, each system can be throttled to its needs and not the combined load.

In one or more embodiments, specific components that can be used for a 250 kW system (common power level for single-engine aircraft such as Piper Matrix, Cirrus SR22, Robinson R44/R66 helicopters, etc):

Multiple fuel cell stacks, each producing up to 125 kW of power. Low-temperature (85 C) PEM (Proton Exchange Membrane, also known as Polymer Electrolyte Membrane) fuel cells with metal bipolar plates can be used. Examples of such LTPEM stacks include the ones from the following companies: Intelligent Energy, Powercell, Horizon Fuel Cells, etc

Multiple high-power density motors, optimized for a range of rotational speeds commonly used in the target aircraft (typically 1,600-2,700 RPM). Generally, such motors will have axial flux design, with relatively large diameters but very short lengths, further facilitating utilization of multiple motors in one system. Example of good choices at this power level include motors from the following companies: EMRAX, YASA, etc.

In one or more embodiments, high power inverters need to deliver high power at low weight, therefore will generally be operating at higher DC bus voltage (e.g., 750V). They will also need to provide sufficient telemetry and controllability to enable control strategies required in managing such multi-motor powertrains. Examples of such inverters include the ones from the companies such as: Sevcon, RMS, etc

In one or more embodiments, cooling pumps may require granular controllability to maximize efficiency of the entire powertrain via matching the cooling fluid flow to real-time conditions. Example of such controllable pumps include products from EMP (e.g., WP29/WP32 pump family), and many others

In one or more embodiments, heat exchangers, alternators, A/C compressors, and other accessories can be generally used aviation accessories.

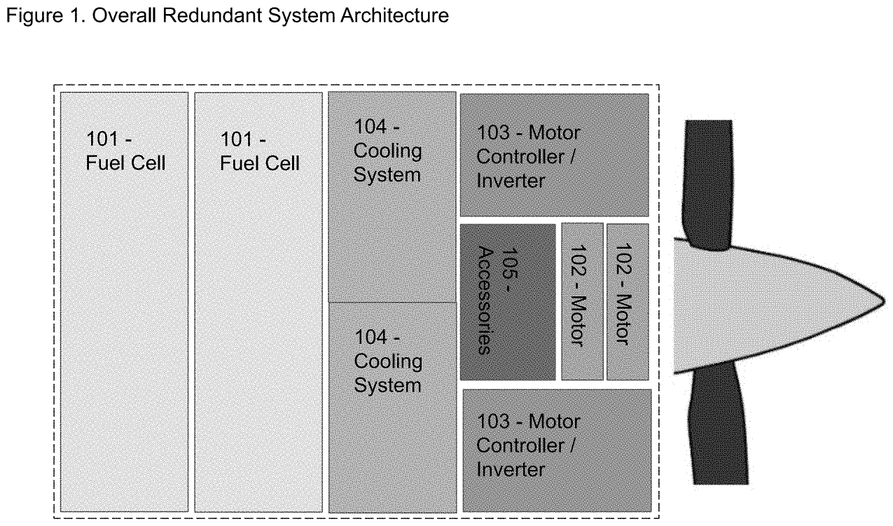

FIG. 1 illustrates overall architecture. Each individual powertrain consists of the following items:

101—Fuel Cell: Provides electric power to inverter.

102—Motor: Generates torque to spin the propulsor's shaft.

103—Inverter: Converts DC electricity from the fuel cell into AC electricity for the motor.

104—Heat exchanger for the cooling system.

105—Airframe accessories, including A/C compressors, heat pumps, vacuum pumps, 28V generators.

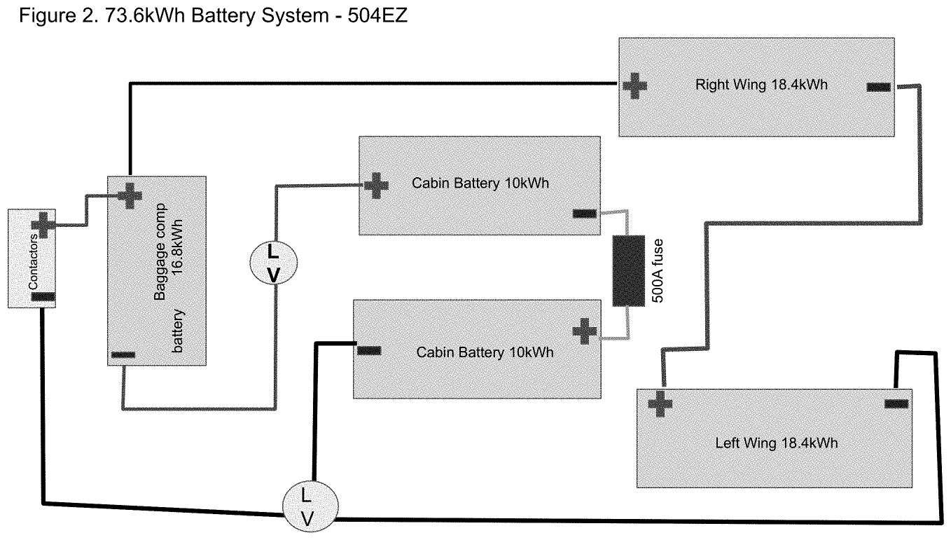

FIG. 2 illustrates example redundant battery system for a 250 kW Piper Matric powertrain.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in aircraft power plants. It is intended that the specification and examples be considered as exemplary only, with a true scope and spirit of the invention being indicated by the following claims.

What is claimed is:

1. An aircraft power plant comprising multiple electric drivetrains combined through a single output shaft, wherein each drivetrain is completely separate from the other, containing individual power sources, motor controllers, and motors, wherein the motors could be selected to provide efficient direct drive to the propulsor at the target propulsor RPM, to facilitate combining multiple motors on the same shaft without requiring mechanical gearboxes.

2. The aircraft power plant of claim 1, wherein during normal operation, each drivetrain will be operating below their maximum output levels, extending the durability of the motor controllers and motors.
